(19) United States
(12) Patent Application Publication
(10) Pub. No.: US 2006/0127764 A1
(43) Pub. Date: Jun. 15, 2006

(54) Electrochemical cells electrodes and binder materials for electrochemical cells electrodes

(76) Inventors: Muguo Chen, South Salem, NY (US); Fuyan Ma, Yorktown, NY (US); Lin-Feng Li, Croton, NY (US)

Correspondence Address: REVEO, INC., 3 WESTCHESTER PLAZA, ELMSFORD, NY, 10523, US

(21) Appl. No.: 11/009,942

(22) Filed: Dec. 10, 2004

(51) Int. Cl. H01M 4/62; H01M 10/26

(52) U.S. Cl. 429/217; 429/206

(57) ABSTRACT

An electrode described herein comprises an ionic binder selected from the group consisting of poly(stryrenesulfonic acid), copolymer consisting poly(stryrenesulfonic acid), salts of poly(stryrenesulfonic acid), salts of copolymer consisting poly(stryrenesulfonic acid), and their derivatives. The herein disclosed binder materials can enhance battery power performance and improve the utilization of electrode material, hence increasing energy density, while maintaining the mechanical integrality of the electrodes using such binder materials.

### BACKGROUND

High power, high energy density, and high cycleability rechargeable batteries are essential for applications such as electrical transportation, power back-up, portable electronics, etc. To achieve high cycleability, a strong binder is usually needed to keep the integrality of electrodes during cycling. Current binders are either non-ionic or not strong enough.

Most Teflon-based binders are not ionic. Most other ionic polymer materials are either soluble in electrolyte or not strong enough as a binder. To be able to distribute the binder uniformly, it is desirable that the binder is soluble in a solvent during the preparation process but not soluble in the electrolyte. For the sake of environmental protection and cost reduction, the ideal solvent is pure water. This kind of ionic polymer material is hard to find, however.

Accordingly, it would be desirable to provide a binder conducive to high power and energy density batteries, by enhancing ionic conductivity while maintaining structural integrity.

### SUMMARY OF THE INVENTION

The above-discussed and other problems and deficiencies of the prior art are overcome or alleviated by the several compositions, wherein an electrode comprises an ionic binder selected from the group consisting of poly(stryrenesulfonic acid) and its derivatives, copolymer consisting poly(stryrenesulfonic acid) and its derivatives, salts of poly(stryrenesulfonic acid) and its derivatives, and salts of copolymer consisting poly(stryrenesulfonic acid) and its derivatives.

The herein disclosed binder materials can enhance battery power performance and improve the utilization of electrode material, hence increasing energy density, while maintaining the mechanical integrality of the electrodes using such binder materials.

The above-discussed and other features and advantages of the present invention will be appreciated and understood by those skilled in the art from the following detailed description and drawings.

### DETAILED DESCRIPTION

The binder for an electrode of a battery or fuel cell as described herein comprises poly(stryrenesulfonic acid), copolymers of poly(stryrenesulfonic acid), salts of poly(stryrenesulfonic acid), and salts of copolymers of poly(stryrenesulfonic acid), and the derivatives of these polymers and copolymers. The herein disclosed polymers generally have structures as follows: 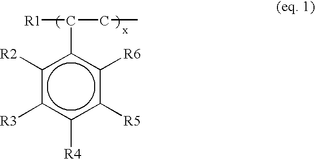
wherein R1 is selected from the group consisting of repeating units of the formula of eq. 1 or a terminal group, and

R2-R6 may be the same or different and selected from the group consisting of H, SO3, CH₃, C2-C6 alkanes, C2-C6 alkenes, C2-C6 alkynes, aromatics, halogens, carboxylic acid and its derivatives, sulfates and nitrates; wherein at least one of R2-R6 comprises SO3, and

“x” is an average number of repeat unit that is greater than or equal to about 100, and in certain embodiments greater than or equal to about 1000, and in further embodiments, greater than or equal to about 3000.

Further, any copolymer having styrene-sulfonate functional groups may be used as binder materials for electrodes as described herein.

In general, preferred compounds of the general equation 1 above or any copolymer having styrene-sulfonate functional are water soluble to form a binder solution. The herein described mixture of electrode material and ionic binder materials described herein is generally enhanced upon contact with suitable electrolyte, as swelling of the ionic binders occurs, increasing conductivity and mechanical strength. The binder solution is mixed with the electrode material to form a slurry. In certain embodiments, the electrodes are contacted with the electrolytes in a “wet” state, that is, in the form of a metal fuel paste. In such embodiments, the binder materials described herein form a uniform network around the anode particle material that is enhanced (i.e., tightened), thereby forming a conductive binding polymer network, upon exposure to electrolyte. In further embodiment, the slurry of binder and electrode materials is applied on an electrode substrate, and allowed to dry (e.g., ambient or heated). In other embodiments, the solution of electrode material and binder material is dried, and the binder materials described herein precipitate within the electrode material. The dried material may be pressed onto an electrode substrate to form an electrode, a conductive binding polymer network is enhanced upon exposure to electrolyte.

The ionic binder systems disclosed herein may also be used with other binder materials. The other binder materials may be any material that generally adheres the electrode material and optionally the current collector to form a suitable structure, and is generally provided in an amount suitable for adhesive purposes of the electrode. This material is preferably chemically stable to the electrochemical environment. In certain embodiments, the binder material is soluble, or can form an emulsion, in water, and is not soluble in an electrolyte solution. Appropriate binder materials include polymers and copolymers based on polytetrafluoroethylene (e.g., Teflon® and Teflon® T-30 commercially available from E.I. du Pont Nemours and Company Corp., Wilmington, Del.), polyvinyl alcohol (PVA), carboxymethyl cellulose, poly(ethylene oxide) (PEO), polyvinylpyrrolidone (PVP), and the like, and derivatives, combinations and mixtures comprising at least one of the foregoing binder materials.

In general, the ionic binder material may be used with the positive electrode, negative electrode, or both electrodes of an electrochemical cell system. For example, in a metal air cell, the ionic binder may be used with the negative metal electrode. In a nickel-zinc, nickel-cadmium, nickel-metal hydride, nickel-iron, silver-zinc, silver-iron, or manganese-zinc electrochemical cell, the ionic binder may be used with the negative zinc electrode and the positive electrodes. Suitable separators are provided between electrodes to prevent electrical shorting yet allows ionic communication as is known in the art of electrochemical cells.

For example, the electrode (e.g., negative electrodes) may comprise electrode materials selected from the group consisting of zinc, cadmium, metal hydride, calcium, lithium, lead, magnesium, ferrous metals, aluminum, oxides of at least one of the foregoing metals, or combinations and alloys comprising at least one of the foregoing metals.

Alternatively, the negative electrode material may be incorporated with an electrolyte, for example, to form a zinc paste. Suitable electrolyte materials include ion conducting material to allow ionic conduction between the metal anode and the cathode. An ion conducting amount of electrolyte may be provided in the negative electrode material. The electrolyte generally comprises ionic conducting materials such as KOH, NaOH, LiOH, other materials, or a combination comprising at least one of the foregoing electrolyte media. Particularly, the electrolyte may comprise aqueous electrolytes having a weight concentration of about 5% ionic conducting materials to about 55% ionic conducting materials, preferably about 10% ionic conducting materials to about 55% 15 ionic conducting materials, and more preferably about 35% ionic conducting materials to about 45% ionic conducting materials.¹
¹ A gelling agent may also be used in sufficient quantity to provide the desired consistency of the paste. The percentage of gelling agent (based on the total electrolyte without zinc material) is generally about 0.2% to about 20%, preferably about 1% to about 10%, more preferably about 1% to about 5%. The gelling agent may be a crosslinked polyacrylic acid (PAA), such as the Carbopol® family of crosslinked polyacrylic acids (e.g., Carbopol® 675, Carbopol® 940) available from Goodrich Corp., Charlotte, N.C., and potassium and sodium salts of polyacrylic acid or polymethyl acrylic acid; carboxymethyl cellulose sodium salt (CMC), such as those available from Aldrich Chemical Co., Inc., Milwaukee, Wis.; hydroxypropylmethyl cellulose; polyvinyl alcohol (PVA); poly(ethylene oxide) (PEO); polybutylvinyl alcohol (PBVA); natural gum; Polygel 4P (available from Sigma-Aldrich); grafted starch, such as Waterlock® A22 1, available from Grain Processing Corp., Muscatine, Iowa; combinations comprising at least one of the foregoing gelling agents; and the like.

Further, the electrode (e.g., positive electrodes) may comprise electrode materials selected from the group consisting of nickel, silver, manganese, and alloys comprising at least one of the foregoing metals.

The metal electrode constituents may be provided in the form of foil, powder, dust, granules, flakes, needles, pellets, fibers, or other particles.

The invention will now be described by way of non-limiting examples.

### EXAMPLE 1

4.5 grams of poly(sodium 4-styrenesulfonate) with average Mw ca. 1,000,000 is dissolved in 40.5 grams of water. 20 grams of zinc powder and 60 grams of zinc oxide powder are added into the solution. The mixture is thoroughly mixed to form slurry. The slurry can be applied to an electrode substrate directly to form an electrode, or may be air dried at room or elevated temperature. The dried mixture is then crushed by a grinder. The thus formed powder is pressed to an electrode substrate to form an electrode. This electrode may be used for Nickel-Zinc, Silver-Zinc, Manganese-Zinc, and other batteries.

### EXAMPLE 2

3.4 grams of poly(sodium 4-styrenesulfonate) with average MW ca. 1,000,000 is dissolved in 30.9 grams of water. The solution is mixed with 10 grams of 60% T-30 emulsion. 20 grams of zinc powder and 60 grams of zinc oxide powder are then added into the solution. The mixture is thoroughly mixed to form slurry. The mixture can be applied to an electrode substrate directly to form an electrode, or is air dried at room or elevated temperature. The dried mixture is then crushed by a grinder. The thus formed powder is pressed to an electrode substrate to form an electrode. This electrode may be used for Nickel-Zinc, Silver-Zinc, Manganese-Zinc, and other batteries.

Various benefits may be derived from the present binder systems and materials. Poly(styrenesulfonic acid), copolymers including styrenesulfonic functional groups, salts thereof, and their derivatives, are strong polymers that provide the mechanical properties needed for a binder. It is an ionic polymer and is slightly swellable in electrolytes such as aqueous KOH solution. The swelling of these ionic binder materials in electrolyte solutions further improves the ionic conductivity as a binder. The system thus provides superior conductivity and binding capability.

While preferred embodiments have been shown and described, various modifications and substitutions may be made thereto without departing from the spirit and scope of the invention. Accordingly, it is to be understood that the present invention has been described by way of illustrations and not limitation.

What is claimed is:

1. An electrochemical cell comprising:
a first electrode, a second electrode and an electrolyte providing ionic conduction between the first electrode and the second electrode,
wherein the first or second electrode comprises the same or different ionic binders selected from the group consisting of poly(stryrenesulfonic acid), copolymer consisting poly(stryrenesulfonic acid), salts of poly(stryrenesulfonic acid), salts of copolymer consisting poly(stryrenesulfonic acid), and their derivatives.

2. The electrochemical cell as in claim 1, wherein the first electrode includes an ionic binder, the first electrode comprising metals adhered by an ionic binder, the metals selected from the group consisting of zinc, cadmium, metal-hydride, calcium, lithium, magnesium, ferrous metals, aluminum, oxides of at least one of the foregoing metals, or combinations and alloys comprising at least one of the foregoing metals.

3. The electrochemical cell as in claim 1, wherein the second electrode includes an ionic binder, the second electrode comprising metals adhered by an ionic binder, the particles selected from the group consisting of nickel, silver, manganese, and alloys comprising at least one of the foregoing metals.

4. The electrochemical cell as in claim 1, wherein the first electrode includes an ionic binder, the first electrode comprising zinc particles adhered by an ionic binder, and further wherein the second electrode includes an ionic binder, the second electrode comprising second electrode metals adhered by the ionic binder, the second electrode metals selected from the group consisting of nickel, silver, manganese, and alloys comprising at least one of the foregoing metals.

5. The electrochemical cell as in claim 1, wherein the electrolyte is alkaline.

6. The electrochemical cell as in claim 2, wherein the electrolyte is alkaline.

7. The electrochemical cell as in claim 3, wherein the electrolyte is alkaline.

8. The electrochemical cell as in claim 4, wherein the electrolyte is alkaline.
